(19) United States
(12) Patent Application Publication
(10) Pub. No.: US 2013/0075649 A1
(43) Pub. Date: Mar. 28, 2013

(54) MAGNETIC GLUE

(71) Applicant: CHIEN-CHUN WANG, Tu-Cheng (TW)

(72) Inventor: CHIEN-CHUN WANG, Tu-Cheng (TW)

(73) Assignee: HON HAI PRECISION INDUSTRY CO., LTD., Tu-Cheng (TW)

(21) Appl. No.: 13/340,610

(22) Filed: Dec. 29, 2011

(30) Foreign Application Priority Data
Sep. 27, 2011 (TW) 100134739

(51) Int. Cl. H01F 1/44; B82Y 30/00

(52) U.S. Cl. 252/62.55; 252/62.51 R; 252/62.56; 977/902

(57) ABSTRACT

A magnetic glue includes a curable glue and magnetic nanoparticles mixed in the curable glue. The magnetic glue is used in a lens module to avoid polluting the optical portion of the lens module.

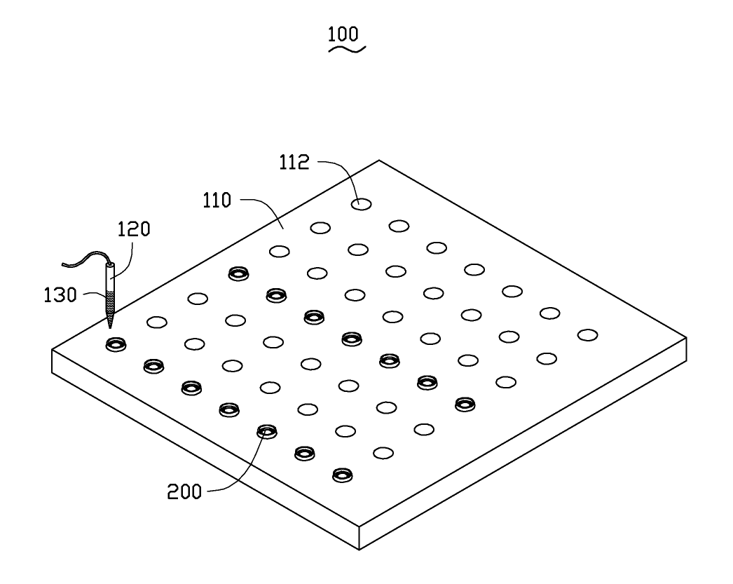

### BACKGROUND

1. Technical Field

The present disclosure relates to glues, particularly to a magnetic glue.

2. Description of Related Art

Lens modules are widely employed in camera systems and mobile phones for image capturing. Generally, a lens module includes a lens barrel, a lens group, a spacer, and a filter (e.g., an IR-cut filter). The lens group, the spacer and the filter are received in the lens barrel and arranged along an optical axis of the lens group, in that order, from the object side to the image side of the lens module. In assembly, the last components mounted into the lens barrel, which may be a lens or a spacer, is bonded to the lens barrel via a glue/adhesive dispensed by a liquid dispenser. Yet, if too much glue is dispensed on the lens or the spacer, the glue will flow to the optical portion of the lens and damages the whole lens module.

What is needed, therefore, is a new glue which could overcome the limitations described above.

### BRIEF DESCRIPTION OF THE DRAWING

Many aspects of the embodiments can be better understood with reference to the following drawings. The components in the drawings are not necessarily drawn to scale, the emphasis instead being placed upon clearly illustrating the principles of the present disclosure.

The FIGURE is an isometric view of a liquid dispenser.

### DETAILED DESCRIPTION

Referring to the FIGURE, a liquid dispenser 100 for use in relation to a lens module 200 in accordance with an embodiment is shown. The lens module 200 includes an inner surface needed to be glued. The liquid dispenser 100 includes a needle 120 and a magnetic support base 110.

The needle 120 is used for releasing magnetic glue 130 into the lens module 200. The magnetic glue 130 is manufactured by adding magnetic nanoparticles into a curable glue. The magnetic nanoparticles are magnetic metal nanoparticles or magnetic metal oxide nanoparticles. The magnetic metal includes iron, cobalt, nickel and alloy of the iron, the cobalt, and the nickel. The size of the magnetic nanoparticles is about 1 nanometer (nm) to about 100 nm. In the embodiment, the curable glue is a light-curable glue. In another embodiment, the curable glue can also be a hot-curable glue. The needle 120 disperses glue by an automatic glue dispersing machine or manually.

The magnetic support base 110 defines a number of holes 112 each for receiving a lens module 200.

A dispensing method for using the liquid dispenser 100 includes the steps described below:

First, the lens modules 200 are put in the holes 112 of the magnetic support base 110. The lens modules 200 are in contact with the inner walls of the holes 112.

Second, the magnetic glue 130 is dispensed into the lens module 200 by the needle 120. The magnetic support base 110 attracts the magnetic glue 130 by a magnetic force and makes the magnetic glue 130 flow towards the inner surface of the lens module 200.

Finally, the magnetic glue 130 is solidified by an ultraviolet light, or heat-cured, as the case may be. The solidified magnetic glue 130 is adhered to the inner surface of the lens module 200 and will not pollute the optical portion of the lens module 200.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A magnetic glue comprising:
a curable glue and magnetic nanoparticles mixed in the curable glue.

2. The magnetic glue of claim 1, wherein the magnetic nanoparticles are selected from the group consisting of magnetic metal and magnetic metal oxide.

3. The magnetic glue of claim 2, wherein the magnetic metal are selected from the group consisting of iron, cobalt, nickel and alloy of iron, cobalt, nickel.

4. The magnetic glue of claim 1, wherein the size of the magnetic nanoparticles is about 1 nanometer to about 100 nanometers.

5. The magnetic glue of claim 1, wherein the curable glue is a light-curable glue.

6. The magnetic glue of claim 1, wherein the curable glue is a hot-curable glue.
